(19) United States
(12) Patent Application Publication
(10) Pub. No.: US 2025/0369816 A1
(43) Pub. Date: Dec. 4, 2025

(54) METHOD AND SYSTEM FOR DETERMINING A PRESSURE OF A LIQUID FLOWING IN A CHANNEL

(71) Applicants: COMMISSARIAT A L'ENERGIE ATOMIQUE ET AUX ENERGIES ALTERNATIVES, Paris (FR); CENTRE NATIONAL DE LA RECHERCHE SCIENTIFIQUE, Paris (FR)

(72) Inventors: Laurence NOIREZ, Gif sur Yvette cedex (FR); Patrick BARONI, Gif sur Yvette cedex (FR)

(73) Assignees: COMMISSARIAT A L'ENERGIE ATOMIQUE ET AUX ENERGIES ALTERNATIVES, Paris (FR); CENTRE NATIONAL DE LA RECHERCHE SCIENTIFIQUE, Paris (FR)

(21) Appl. No.: 18/876,497

(22) PCT Filed: Jun. 23, 2023
(86) PCT No.: PCT/FR2023/050955

§ 371 Date: Dec. 18, 2024

(30) Foreign Application Priority Data
Jun. 24, 2022 (FR) 2206312

(51) Int. Cl. G01L 11/00; G01J 5/00; G01K 1/143; G01K 3/08; G01K 13/02; G01L 27/00

(52) U.S. Cl. CPC G01L 11/002; G01J 5/0037; G01K 1/143; G01K 3/08; G01K 13/026; G01L 27/002; G01J 2005/0077

(57) ABSTRACT

A measurement system is configured to determine a pressure of a liquid of interest having compressibility kₘ flowing in a channel of radius rᵢₙₜ, which are selected such that the product kₘ×rᵢₙₜ is less than or equal to 12.5×10⁻¹¹ mm/Pa. The system includes a flow actuator for flowing the liquid of interest in the channel at a Mach number less than or equal to 0.3, a thermal measurement device for measuring a temperature of the liquid of interest flowing in the channel, and a processing unit configured to determine the pressure from the temperature measured and a predetermined calibration function.

### TECHNICAL FIELD

The field of the invention is that of determining pressure of a liquid flowing in a channel, and in particular in a millifluidic or even microfluidic channel.

### STATE OF PRIOR ART

Microfluidics relates to the flow of liquids in channels of submillimetre transverse dimensions, and its applications usually cover the physical, chemical, life, biological, medical, environmental, process and engineering sciences.

Depending on the applications, it may be important to know the pressure of a liquid flowing in a microfluidic channel. For this, a pressure sensor which can include a membrane or a deformable diaphragm which separates two spaces, one being the place where the liquid flows and the other being brought to a reference pressure, is usually used. The pressure difference between both spaces results in a deformation of the diaphragm, and by measuring the deformation intensity (or vibration frequency) the pressure of the flowing liquid can be deduced. However, due to the dimensions of the diaphragm, the pressure sensor is usually disposed upstream or downstream of the channel, in a zone in the fluid circuit where transverse dimensions are sufficiently large. Pressure is therefore not measured within the microfluidic channel itself, which can result in erroneous values being provided. In addition, the pressure sensor may be subject to measurement drift, especially if it is subject to degradation or progressive fouling of the membrane, especially when used over long periods of time.

### DESCRIPTION OF THE INVENTION

One purpose of the invention is to remedy, at least in part, the drawbacks of prior art, and more particularly to provide a measurement system and its method for determining pressure of a liquid flowing in a channel. Such a measurement system offers improved reliability insofar as the pressure is determined from a thermal measurement and a predetermined calibration function, and not indirectly from values from a remote pressure sensor whose performance is moreover likely to degrade.

For this, one object of the invention is a measurement system adapted to determine at least one pressure P_{heq} of a liquid of interest having compressibility kₘ flowing in a channel of internal radius rᵢₙₜ, the liquid of interest and the channel being selected so that the product kₘ×rᵢₙₜ is less than or equal to 12.5×10⁻¹¹° mm/Pa. It includes°: the channel°; a flow actuator, adapted to cause the liquid of interest to flow in the channel, so that the liquid of interest has a ratio Vₘ/c less than or equal to 0.3, where Vₘ is a maximum velocity of the liquid of interest in the channel and where c is a velocity of sound in the liquid of interest; a thermal measurement device, adapted to measure at least one temperature T_{heq} of the liquid of interest flowing in the channel; and a processing unit, adapted to determine pressure P_{heq} from the temperature T_{heq} measured and a predetermined calibration function f, expressing a course of a pressure difference ΔP between the pressure P_{heq} and a predefined reference pressure P_{eq}of the liquid of interest at rest in the channel, as a function of a temperature difference ΔT between the temperature T_{heq} measured and a predefined reference temperature T_{eq} of the liquid of interest at rest in the channel.

The temperature difference ΔT between value T_{heq} measured and predefined value T_{eq} can be determined by the processing unit. The predefined value T_{eq} can be recorded in a memory of the processing unit. Alternatively, this temperature difference ΔT can be determined by the thermal measurement device itself, which would then integrate the predefined value T_{eq} into a memory and provide the value ΔT directly to the processing unit.

The calibration function f expresses a variation, i.e. a course, of the pressure difference ΔP as a function of the temperature difference ΔT: ΔP=f(ΔT). It is therefore understood that the terms “variation” and “course” have the same meaning. This variation or course may be positive or negative. In addition, the calibration function f can be an affine function defined by the relationship: ΔP=β×ΔT, where β is a predetermined positive or negative (and for example positive) constant with ΔP=P_{heq}−P_{eq} and ΔT=T_{heq}−T_{eq}.

The channel can have a length of less than or equal to 5 cm.

It can be rectilinear along its entire length and have a constant internal radius rᵢₙₜ.

The flow actuator may include ducts connecting the channel to a pump and to a tank for the liquid of interest, the ducts having an internal radius greater than rᵢₙₜ.

The thermal measurement device can be adapted to detect infrared radiation emitted by the liquid of interest and transmitted by a peripheral wall of the channel and to deduce the temperature T_{heq}, the peripheral wall being made of a material transparent to infrared radiation.

The thermal measurement device may include at least one contact thermal sensor, disposed in contact with a peripheral wall of the channel.

The thermal contact sensor can be disposed in contact with an external face of the peripheral wall, which is made of a thermally conductive material so that the temperature of the external face is equal to the temperature T_{heq} of the liquid.

The channel can have an internal diameter dᵢₙₜ of between 10 μm and 1 mm.

The thermal measurement device can be adapted to acquire a thermal image of the liquid of interest, and the processing unit can be adapted to determine a pressure image from the thermal image acquired and the calibration function f.

Another object of the invention is a method for determining a pressure P_{heq} of a liquid of interest moving in the channel of the measurement system according to any of the preceding characteristics, the method including a measurement phase comprising the following steps:
selecting a liquid of interest having a compressibility km and the channel of internal radius rᵢₙₜ, so that a product kₘ×rᵢₙₜ is less than or equal to 12.5×10⁻¹¹ mm/Pa;
flowing the liquid of interest in the channel at a flow rate predefined by the flow actuator, so that it has a ratio Vₘ/c less than or equal to 0.3, where Vₘ is a maximum velocity of the liquid in the channel and where c is a velocity of sound in the liquid of interest;
measuring a temperature T_{heq} of the liquid of interest flowing in the channel by the thermal measurement device, and determining a temperature difference ΔT which is then non-zero between the temperature T_{heq} measured and a predefined reference temperature T_{eq} of the liquid of interest at rest;
determining the pressure P_{heq} of the liquid of interest by the processing unit, from the temperature difference ΔT determined, and from a predetermined calibration function f, expressing a course of a pressure difference ΔP between the pressure P_{heq} of the liquid of interest flowing in the channel and a predefined reference pressure P_{eq} of the liquid of interest at rest, as a function of the temperature difference ΔT.

The method can include a calibration phase, carried out before the measurement phase, including the following steps:
selecting a liquid having compressibility k_{c} and a channel of internal radius rᵢₙₜ of a calibration system, so that a product k_{c}×rᵢₙₜ is less than or equal to 12.5×10⁻¹¹ mm/Pa;
flowing the liquid in the channel by a flow actuator of the calibration system at a predefined flow rate, so that it has a ratio Vₘ/c less than or equal to 0.3, where Vₘ is a maximum velocity of the liquid in the channel and where c is a velocity of sound in the liquid;
measuring a temperature T_{heq} of the liquid flowing in the channel by a thermal measurement device of the calibration system, and determining a temperature difference ΔT which is then non-zero between the temperature T_{heq} measured and a predefined reference temperature T_{eq} of the liquid at rest;
measuring a pressure P_{heq} of a liquid flowing in the channel by a pressure sensor of the calibration system, and determining a pressure difference ΔP which is then non-zero between the pressure P_{heq} measured and a predefined reference pressure P_{eq} of the liquid at rest°;
reiterating the steps of measuring temperature T_{heq} and pressure P_{heq} for different flow rates of the liquid in the channel;
determining the calibration function f, by a processing unit of the calibration system from the different values of the temperature deviation ΔT and the corresponding values of the pressure deviation ΔP.

The liquid of interest can be selected from water, an alcohol and glycerol.

The liquid of interest may be identical to the liquid used during the calibration phase

Flowing the liquid of interest can be carried out by suction, so that the temperature T_{heq} measured is then lower than the reference temperature T_{eq} and corresponds to cooling of the liquid of interest; or can be carried out by discharge, so that the temperature T_{heq} measured is then higher than the reference temperature T_{eq} and corresponds to heating of the liquid of interest.

The channel can be made of a thermally conductive material, and in thermal contact with an outer device, so that cooling or heating of the liquid of interest causes cooling or heating of the outer device respectively.

### BRIEF DESCRIPTION OF THE DRAWINGS

Other aspects, purposes, advantages and characteristics of the invention will become clearer upon reading the following detailed description of preferred embodiments thereof, given as a non-limiting example, and made with reference to the appended drawings in which:

FIG. 1A is a schematic partial view of a measurement system according to one embodiment, adapted to determine pressure of a liquid flowing in a channel;

FIG. 1B is a partial schematic longitudinal cross-section view of the channel of the measurement system;

FIG. 1C is a schematic partial transverse cross-sectional view of the channel and the thermal measurement device of the measurement system;

FIG. 2A illustrates an example of a calibration function f expressing a course of a pressure difference ΔP as a function of a temperature difference ΔT;

FIG. 2B is a schematic partial view of a calibration system according to one embodiment, adapted to determine the calibration function f;

FIG. 3 is a flow chart of a method for determining pressure of a liquid flowing in the channel, here including a preliminary phase of determining the calibration function f.

### DETAILED DESCRIPTION OF SPECIFIC EMBODIMENTS

In the figures and in the remainder of the description, the same references represent identical or similar elements. In addition, the different elements are not shown to scale so as to promote clarity of the figures. Moreover, the different embodiments and alternatives are not mutually exclusive and can be combined together. Unless indicated otherwise, the terms “substantially”, “about”, “approximately” mean within 10%, and preferably within 5%. Moreover, the terms “between . . . and . . . ” and the like mean that the bounds are included, unless stated otherwise.

The invention is directed to the determination of a pressure P_{heq} of a liquid flowing in a channel, not from a dedicated pressure sensor, but from a measurement of a temperature of the liquid (and more precisely a temperature difference ΔT) and by means of a predetermined calibration function f. The liquid whose pressure is to be determined here is referred to as the “liquid of interest”, thus distinguishing it from the liquid used to establish the calibration function beforehand. The liquid of interest, like the calibration liquid, is a liquid having density ρ, dynamic viscosity μ, and compressibility k.

Within the scope of the usual theory of fluid mechanics, a liquid is considered to be incompressible when its volume, and therefore the density of each liquid particle, remains constant during movement. So the density ρ is a constant throughout the flow and at any moment in time. This is in particular the case when the corresponding Mach number is low, usually less than 0.3, or even less than 0.1, or less. The Mach number is defined by the relationship: Ma=Vₘ/c where Vₘ is the maximum velocity of the flowing liquid and c is the speed of sound in the liquid in question.

Thus, in an incompressible liquid, since the velocity field is by definition zero divergence, effects of expansion and compression of the liquid are assumed to be non-existent. Thus, the equations of the conventional liquid mechanics model for an incompressible liquid (continuity, dynamic and energy equations) result in the dynamic problem (velocity, pressure) being decoupled from the thermal problem. Thus, in incompressible flow, it is usually assumed that the pressure of a liquid has no thermodynamic influence, and that the dynamic and thermal problems can be solved independently of each other.

However, the inventors have noticed that this conventional theoretical framework is not always true in the case of moving liquids when a condition on the product of the compressibility k of the liquid and a characteristic transverse dimension rᵢₙₜ of the channel is verified (this condition is explained later). This is in particular the case in millimetre, micrometre and even nanometre-sized channels. They thus demonstrated that liquids usually considered to be incompressible in flow exhibit some compressibility, i.e. related to an elasticity (referred to as shear elasticity), the physical effect of which is all the greater the smaller the characteristic dimension rᵢₙₜ of the channel.

Therefore, moving such a liquid in a channel while respecting the condition on the product k×rᵢₙₜ is tantamount to invoking shear elasticity of the liquid, and therefore putting it out of thermodynamic equilibrium by thermoelastic effect (that could also be referred to as an “elasto-caloric” effect). Indeed, thermoelastic coupling is present, so that flowing the liquid results in heating (mechanical compressive stress) or cooling (mechanical tensile stress). A presentation of thermoelasticity related to mesoscopic shear elasticity can be found especially in the article by Kume et al. entitled Strain-induced violation of temperature uniformity in mesoscale liquids, Sci Rep, 10, 13340 (2020).

The inventors have developed a measurement system and a method for determining the pressure of a liquid, taking advantage of this thermoelastic effect applied to flow in channels whose characteristic dimension rᵢₙₜ satisfies the condition on the product k×rᵢₙₜ. Such a measurement system avoids the drawbacks of pressure sensors of prior art mentioned previously, insofar as the pressure of a flowing liquid is determined in situ in a measurement zone in the channel, from a thermal measurement (therefore by a measurement which does not disturb flow of the liquid), and from a predetermined calibration function.

Note, moreover, that this variation in the temperature of the liquid of interest due to the thermoelastic effect differs from heating due to an effect of the viscous friction type (such an effect is not, moreover, capable of causing cooling of the liquid). Indeed, heating by viscous dissipation is conventionally expected when the liquid flows at a velocity close to that of sound (Ma≈1), which does not correspond to the scope of the invention.

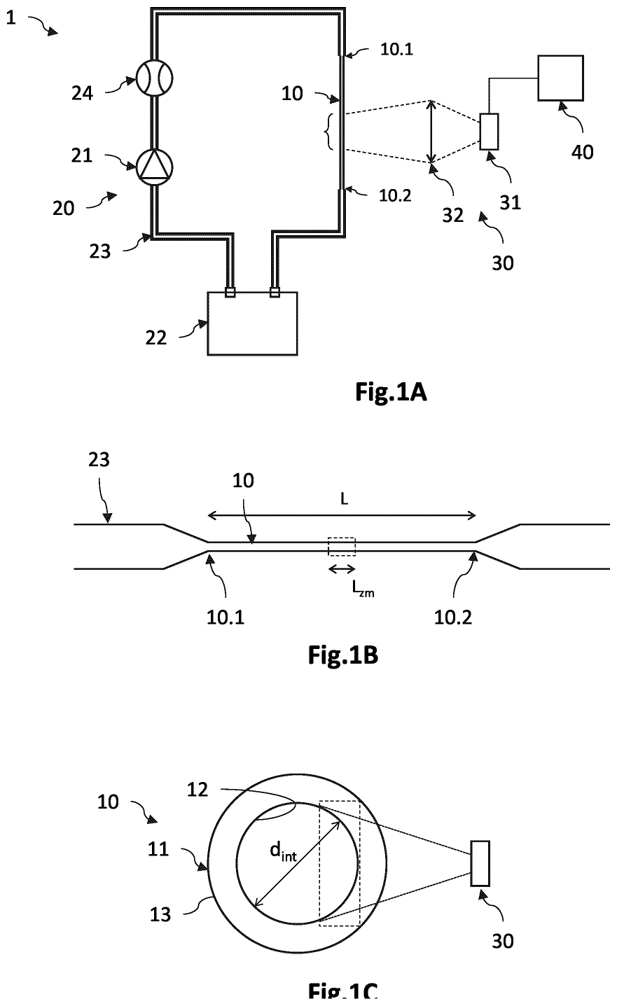

FIG. 1A is a partial schematic view of a measurement system 1 according to one embodiment, adapted to determine a pressure of a liquid of interest flowing in a channel 10. FIGS. 1B and 1C are schematic partial longitudinal and transverse cross-section views of the channel 10 of the measurement system 1 of FIG. 1A.

Generally speaking, the measurement system 1 includes the channel 10, a device 20 for moving the liquid of interest in the channel 10 (referred to as a flow actuator), a thermal measurement device 30 adapted to measure temperature of the liquid in the channel 10, and a processing unit 40 adapted to determine pressure of the liquid in the channel 10 from the temperature measured (and more precisely from a temperature difference ΔT) and the predetermined calibration function f.

The channel 10 is a flow duct formed of a peripheral wall 11 having an internal face 12, which delimits the liquid flow cross-section, and an external face 13 opposite thereto. The channel 10 extends longitudinally between a first end 10.1 and a second end 10.2, over a length L. The fluid flow transverse cross-section of the channel 10 may be circular (tube) or oval, or polygonal, for example square, octagonal. The channel 10 preferably has an aspect ratio equal to 1, the aspect ratio being defined from two transverse internal dimensions of the channel 10 which are orthogonal to each other. A transverse internal dimension dᵢₙₜ of the channel 10, referred to as the internal diameter or equivalent internal diameter, is defined as the diameter of a disc having the same area as the fluid flow cross-section of the channel 10. The internal radius rᵢₙₜ is equal to half the diameter dᵢₙₜ. In the following description, by way of illustration, the channel 10 is a cylindrical tube with a circular cross-section.

The inner radius rᵢₙₜ is selected as a function of the compressibility value kₘ of the liquid so that the following condition is satisfied: kₘ×rᵢₙₜ≤12.5×10⁻¹¹ mm/Pa. When this condition is met, the inventors have noticed that the liquid flowing in the duct 10 has a thermoelastic effect which results in a variation of the temperature T_{heq} of the liquid relative to the temperature T_{eq} of the liquid at rest. Also, when the compressibility kₘ of the liquid is in the order of 10⁻⁹ to 10⁻¹¹ Pa⁻¹ (here in the case of a liquid), the internal radius rᵢₙₜ of channel 10 may be in the order of a few microns, or even tens or hundreds of microns, or even in the order of one millimetre or ten millimetres. Thus, within the scope of a microfluidic or millifluidic flow, the internal diameter dᵢₙₜ may be between 1 μm and 10 mm, or even between 10 μm and 1 mm.

The channel 10 can extend in rectilinear or even curved fashion along its entire length. It can also be rectilinear or curved in the thermal measurement zone. Its diameter dᵢₙₜ may be constant over its entire length, or may vary. The length L may be less than or equal to 5 cm if the presence of thermal instabilities along the longitudinal axis of the channel 10 is desired to be limited or avoided.

The peripheral wall 11 of the channel 10 can be made of a material transparent to infrared light radiation, for example LWIR (Long Wavelength Infrared), in the case where the thermal measurement device 30 is based on measurement by infrared detection. Alternatively, in the case where the thermal measurement device 30 includes one or more thermistors located in contact with the external face 13 of the peripheral wall 11, the latter is made of a material with sufficient thermal conductivity for the external face 13 to have a temperature equal to that of the liquid. Thus, the material of the peripheral wall 11 (and hence its optical and thermal properties) depends on the type of thermal measurement device 30 used, as described in detail later.

The liquid of interest is a material that can flow in the channel. This could be, for example, a viscous Newtonian or non-Newtonian liquid, such as water, glycerol, alcohol, a molten polymer, physiological or body fluids (blood, lymph, serum, etc.), colloidal solutions, among others. It has a dynamic viscosity μₘ, a density ρₘ, and a compressibility kₘ. The compressibility kₘ may be equal to a few units or a few hundred 10⁻¹¹ Pa⁻¹. By way of example, kₘ is equal to 3.7×10⁻¹¹ Pa⁻¹ for mercury, to 45.8×10⁻¹¹ Pa⁻¹ for water, and to 110×10⁻¹¹ Pa⁻¹ for ethanol.

As indicated previously, the liquid of interest having compressibility kₘ and the channel 10 of internal radius ᵣᵢₙₜ are selected so that the following condition is satisfied: kₘ×rᵢₙₜ≤12.5×10⁻¹¹ mm/Pa. When this condition is met, the liquid flowing in channel 10 exhibits a homogeneous thermoelastic effect which leads to a variation in the liquid temperature T_{heq} relative to the temperature T_{eq} of the liquid at rest.

The measurement system 1 includes a flow device 20, also referred to as a flow actuator, adapted to ensure that the liquid of interest flows in the channel 10 at a predefined flow rate D, which may or may not be constant. The flow can thus be continuous along one direction or time-dependent and can have a flow rate that may vary or remain constant.

The flow actuator 20 thus includes at least one pump 21 (i.e. a device adapted to move the liquid by discharge or suction), at least one tank 22 for the liquid of interest, and connecting ducts 23 which ensure fluidic connection of the channel 10 to the pump 21 and to the tank 22. The pump or pumps 21 are directly connected to the ducts 23, and are not located in the duct 10 so as to avoid disturbing the flow of the liquid in the duct 10 and thus degrading quality of the temperature measurement of the liquid.

In this example, the measurement system 1 includes a single pump 21, disposed between the tank 22 and the first end 10.1 of the channel 10. This may be a micropump, such as a peristaltic micropump, or any equivalent device (syringe driver, for example). Pump 21 is adapted to ensure flow of the liquid in the channel 10 at a predefined flow rate D, which may or may not be constant.

A flow meter 24 is preferably connected to the channel 10, and is herein located between the pump 21 and the first end 10.1 of the channel 10. The flow rate D of the liquid in the channel 10 can be deduced from the value measured by the flow meter 24. Preferably, the pump 21 is configured so that the flow rate of the liquid in the channel 10 is less than or equal to a predefined maximum value Dₘ if it is desired to avoid presence of thermal instabilities along the longitudinal axis of the channel 10. The maximum flow rate Dₘ especially depends on the nature of the liquid, and is about 416 mm³/s in the case of water, and 2.5 mm³/s for an alcohol.

The tank 22 for the liquid is herein connected to both ends of the channel 10. The liquid has a predefined pressure therein, which herein may be atmospheric pressure Pₐₜₘ. This pressure also corresponds to the reference pressure P_{eq} of the liquid when it is at rest in the channel 10.

The connecting ducts 23 therefore provide the fluid connection between the tank 22, the pump 21 and the channel 10. They have an internal diameter which may be greater than the diameter dint of the channel 10, for example by a ratio of 2, 5, 10 or even more.

Of course, other configurations are possible. Thus, a second pump can be located between the tank 22 and the second end 10.2. In addition, several tanks can be used. The tank(s) may also contain the liquid of interest at excess pressure, in which case the pump(s) may not be required, and a valve is provided to allow or block flow of the liquid.

It is noted that the arrangement of the pump 21 in relation to the channel 10 and the direction of the imposed flow define the type, compressive or tensile, of mechanical stress undergone by the liquid in the channel 10, and therefore the sign of the temperature variation ΔT (heating or cooling).

Thus, in this example where the pump 21 is located between the tank 22 and the first end 10.1 of the duct 10, a direction of flow oriented from the first end 10.1 to the second end 10.2 results in the liquid in the duct 10 being subjected to compressive mechanical stress, resulting in heating due to the thermoelastic effect. The liquid then has a temperature difference ΔT=T_{heq}−T_{eq} with a positive sign and a pressure difference ΔP=P_{heq}−P_{eq} also with a positive sign. T_{eq} and P_{eq} herein denote the temperature and pressure of the liquid at rest in the channel 10 (“eq” stands for “in thermodynamic equilibrium”), and T_{heq} and P_{heq} the temperature and pressure of the liquid flowing in the channel 10 (“heq” stands for “out of thermodynamic equilibrium”).

Conversely, in the case where the direction of flow imposed by the pump 21 is from the second end 10.2 to the first end 10.1, the liquid flowing in the channel 10 undergoes tensile mechanical stress, resulting in cooling by thermoelastic effect. The liquid then has a temperature difference ΔT with a negative sign and a pressure difference ΔP also with a negative sign.

Finally, it is noted that the thermoelastic effect results in the temperature T_{heq} and pressure P_{heq} of the liquid flowing in the channel 10 are substantially constant along the longitudinal axis of the channel 10 (in the case where there is no flow instability), whereas the temperature in the ducts 23 may be substantially equal to the reference temperature (room temperature), and the difference in pressure between a high pressure imposed by the pump 21 and the ambient pressure of the tank 22 induces flow of the liquid. The fact that the pressure of the liquid flowing in the channel 10 is substantially constant therein is due to the fact that, upon activating the pump 21, the liquid present in the channel 10 initially resists flow due to interactions with the peripheral wall 11 up to a threshold, and is then moved. Thermoelastic coupling is then present, so that the liquid has a temperature T_{heq} and a pressure P_{heq} which are spatially substantially constant along the longitudinal axis of the channel 10, which corresponds to the out-of-thermodynamic equilibrium state of the liquid.

The measurement system 1 also includes a thermal measurement device 30, adapted to determine a value for the temperature of the liquid in the channel 10. It can be of the non-contact type, for example by optical detection of infrared radiation, or of the contact type.

Preferably, the thermal measurement device 30 is of the non-contact type, and includes a photodetector 31 for light radiation emitted or originating from the liquid present in the channel 10, for example infrared radiation. The photodetector 31 can be a matrix photodetector (imager) or a non-matrix photodetector (photodiode). It can be a bolometer or a microbolometer, a CCD or CMOS sensor (or an equivalent, for example BS-CMOS . . . ), or an optical pyrometer. The light radiation to be detected can be in the infrared range, i.e. with a wavelength of between about 0.7 μm and 16 μm. It can be included in the Near Infrared (NIR) range from about 0.78 to 1 μm, in the Short Wavelength Infrared (SWIR) range from about 1 to 2.7 μm, be in the Middle Wavelength Infrared (MWIR) range from 3 to 5 μm, or even be in the Long Wavelength Infrared (LWIR) range from 7 μm to 14 μm.

In this example, a matrix photodetector 31 (imager) is used, which includes a matrix of microbolometers forming 382×288 detection pixels. Each detection pixel has dimensions of 20 μm on a side in the focal plane. Thermal sensitivity is in the order of ±0.02° C. over a nominal range of about 15-25° C. The thermal measurement device 30 also includes one or more optical elements 32 for shaping the incident light radiation, for example one or more lenses. The depth of field especially depends on the liquid and can be in the order of a hundred microns or even more. In addition, the thermal image detected corresponds to a measurement zone in the channel 10, which may have a height H_{zm} at least equal to the diameter dᵢₙₜ of the channel 10, and a length L_{zm} which may be equal to one or more times dᵢₙₜ, for example equal to about 5 mm.

From the thermal image detected, the thermal measurement device 30 determines a temperature value for the liquid in the channel 10. This value can be a mean, possibly weighted, calculated from values of the thermal image or a detailed thermal mapping. This means that values far from the peripheral wall 11 can be given more weight, or not. The value determined thus corresponds to the temperature T of the liquid in the channel 10, i.e. the temperature T_{eq} when the liquid is at rest, and the temperature T_{heq} when the liquid is flowing. This temperature value is transmitted to the processing unit 40. Alternatively, the thermal image (thermal mapping) is transmitted to the processing unit 40, which deduces a pressure image (pressure mapping) therefrom.

In the case where the thermal measurement device 30 is of the optical type, the peripheral wall 11 is formed of a material which is either transparent to the light radiation to be detected, i.e. the transmission coefficient is at least equal to 50% or even 75% or even 90% of the light radiation to be detected, or is opaque to the light radiation to be detected but has a high thermal conductivity coefficient so that the light radiation is that emitted by the external face 13 of the peripheral wall 11. Transparent materials include calcium fluoride (CaF₂), germanium (Ge), potassium bromide (KBr) and some plastics, among others. In the case where the material is opaque, the thickness of the peripheral wall 11 is preferably less than or equal to the internal diameter dᵢₙₜ.

Alternatively, or complementarily, the thermal measurement device 30 may include one or more thermal contact sensors, each formed of a thermistor material located in contact with the peripheral wall. In the case where the thermistor material is in contact with the internal face 12 of the peripheral wall 11, it is in contact with the liquid and is connected to the processing unit 40 by means of an electric cable sealingly passing through the peripheral wall 11. However, preferably the thermistor material is in contact with the external face 13 of the peripheral wall 11, in which case the peripheral wall 11 is made of a thermally conductive material so that the temperature of the external face 13 of the peripheral wall 11 is substantially equal to that of the liquid, or so that the temperature of the liquid can be deduced from the temperature of the peripheral wall 11 by means of a predefined physical model of thermal conductivity.

The processing unit 40 is adapted to determine pressure of the liquid in the channel 10, on the one hand from the temperature Teq measured by the thermal measurement device 30 (and more precisely from a temperature difference ΔT) and on the other hand from the calibration function f. It therefore includes a calculator comprising at least one microprocessor and at least one memory where the calibration function f is stored. As previously indicated, the processing unit 40 can receive at least one temperature value, for example one or more thermal values, and for example a thermal image (thermal mapping), in order to deduce at least one corresponding pressure value, or even a pressure image (pressure mapping) therefrom.

The calibration function f expresses a course (i.e. a variation) in the pressure difference ΔP=Pheq−Peq as a function of the temperature difference ΔT=Theq−Teq of the liquid in the channel 10: ΔP=f(ΔT). It is a continuous function which is preferably an affine function, but it can also be a polynomial, logarithmic or even exponential function. It is parameterised over the preliminary calibration phase, as detailed later. Thus, when the temperature difference ΔT is zero, the pressure difference ΔP is also zero. As previously stated, the temperature difference ΔT can have positive values (heating) so that the pressure difference ΔP is also positive (liquid in compression), but it can also have negative values (cooling) so that the pressure difference ΔP is also negative (liquid in tension).

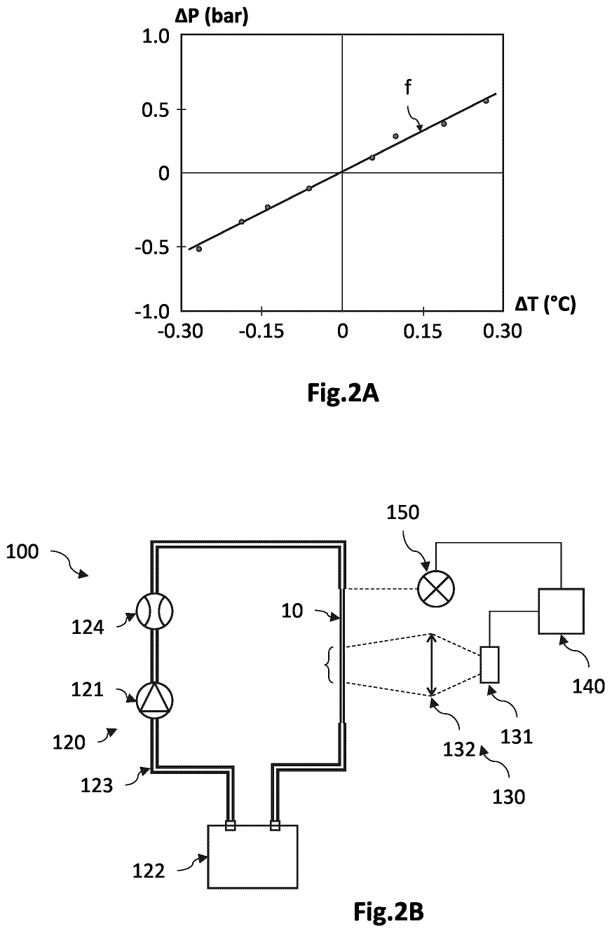

FIG. 2A illustrates an example of such a calibration function f, determined for water flowing in a tubular channel 10 with a diameter of 0.3 mm, where the temperature T_{eq} of the liquid at rest is the room temperature of about 20° C. The temperature has been measured by means of a contact thermal sensor, the peripheral wall of channel 10 being made of a material that is opaque to infrared radiation, herein silicate glass, with a high thermal conductivity. Moreover, the peripheral wall 11 has an external diameter of 0.8 mm. It is observed that a variation |ΔT| of 0.34° C.±0.02° C. results in a variation |ΔP| of 0.68 bar. The calibration function f herein is an affine function ΔP=β×ΔT, where β is a constant equal to about 2 bar/° C. Preferably, the pressure difference ΔP is between −1 bar and +1 bar, and more preferably between −0.5 bar and +0.5 bar.

FIG. 2B is a schematic and partial view of an example of a calibration system 100, adapted to determine the calibration function f which is then recorded in the processing unit 40 of the measurement system 1.

The calibration system 100 is similar to the measurement system 1, in that it includes a channel 110, a flow actuator 120, a thermal measurement device 130 and a processing unit 140. However, unlike the measurement system 1, it includes at least one pressure sensor 150 adapted to measure pressure of the liquid in the channel 10. The pressure sensor 150 may be a strain gauge, capacitive, piezoelectric type sensor, etc. Several pressure sensors 150 can be disposed along the channel 10, so as to obtain a more precise value of pressure of the liquid. Moreover, it is noted that the dimensions of channel 110 are identical to those of measurement system 1.

The calibration system 100 and the measurement system 1 are advantageously two distinct systems, so that the calibration system 100 is used to determine the calibration function f once, and the measurement system 1 is then used to determine pressure of a liquid flowing in the channel 10 from the calibration function f thus determined. This may be the same system, wherein the measurement system 1 corresponds to the calibration system 100 in which the pressure sensor(s) 150 would have been removed. It is noted that the liquid whose pressure is to be determined by the measurement system 1 may be different from that used to determine the calibration function f, except of course that they both satisfy the condition on the product k×rᵢₙₜ. Preferably, these two liquids have a same compressibility value k (to within 10%, or even within 5%, or even less), and preferably they are the same liquids.

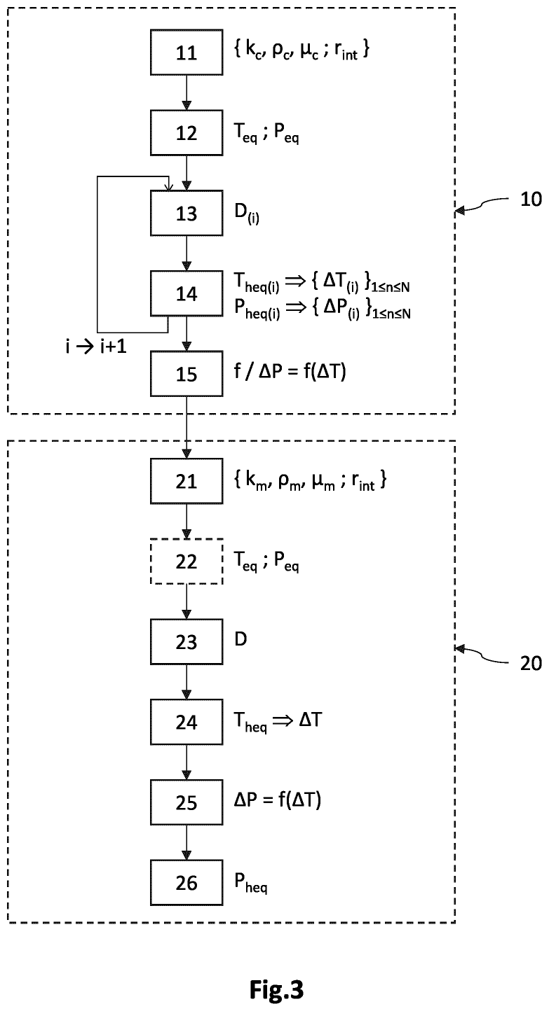

FIG. 3 illustrates different steps of a method for determining pressure of the liquid flowing in channel 10 of a measurement system 1, as well as a preliminary phase of determining the calibration function f.

The calibration phase 10 is first carried out by the calibration system 100.

During a step 11, a liquid having density ρ_{c}, viscosity μ_{c} and compressibility k_{c} is selected. A channel 110 of an internal radius rᵢₙₜ is also selected. The liquid and the channel 110 are therefore selected SO that the product K_{c}×rᵢₙₜ is less than or equal to 12.5×10⁻¹¹ mm/Pa. In addition, the channel 110 has a length L of less than or equal to 5 cm, and the internal diameter dᵢₙₜ is less than or equal to 1 mm, and preferably between 10 μm and 1 mm.

During a step 12, the liquid is at rest in the channel 110. The temperature T_{eq} and pressure P_{eq} of the liquid at rest are defined and recorded in the processing unit 140 of the calibration system 100. These values may simply be defined by the user (without measurements), or may have been previously measured, for example by means of the thermal measurement device 130 or another temperature sensor (not represented), or by means of the pressure sensor 150 or another pressure sensor (not represented).

During a step 13, the flow actuator 120 moves the liquid in the channel 110 (constant flow rate in this example). More precisely, the pump 121 ensures flow of the liquid from the tank 122, so that it flows in the ducts 123 and in the channel 110, and herein back into the tank. The flow rate D of the liquid in the channel 110 is measured to ensure that it does not exceed a predefined maximum value Dₘ, which value depends on the nature of the liquid. Thus, with regard to water, the flow takes place without the flow exceeding about 416 mm³/s in the channel 110.

In a step 14, whereas the liquid is flowing in the channel 110 at a flow rate D₍ᵢ₎ the temperature T_{heq(i)} of the liquid in the channel 110 is measured by means of the thermal measurement device 130, as well as its pressure P_{heq(i)} by means of the pressure sensor 140. The increment i thus varies from 1 to N, where N is the total number of measurements made. The temperature difference ΔT₍ᵢ₎=T_{heq}(i)−T_{eq} and the pressure difference ΔP₍ᵢ₎=P_{heq(i)}−P_{eq} are then determined. A pair (ΔT₍ᵢ₎; ΔP₍ᵢ₎) is thus obtained, and the measurements are repeated for different flow rate values D₍ᵢ₎ by incrementing the value of i. The number N is at least 1, given that the pair (ΔT=0; ΔP=0) is present by definition, but it can be at least 6, with at least 3 measurements for ΔT>0, and at least 3 measurements with ΔT<0.

During a step 15, the processing unit 140 determines the calibration function f, i.e. it determines parameters of the function (for example the constant β in the case of an affine function) from the measured values of the temperature and pressure differences, for example by linear regression. The calibration system 100 has thus determined the calibration function f, which is then transferred if necessary to the processing unit 40 of the measurement system 1.

The phase of measuring 20 the pressure of a liquid of interest can then be carried out by the measurement system 1.

During a step 21, the liquid of interest is selected. It is, much like the liquid used for calibration, a liquid. It has a density ρₘ, a viscosity μₘ and a compressibility kₘ equal to k_{c} within 10%, i.e. to within 10% or even less. Preferably, the liquid of interest is identical to the liquid used for calibration. Thus, as channel 10 is identical to that of the calibration system, the product kₘ×rᵢₙₜ satisfies the condition kₘ×rᵢₙₜ≤12.5×10⁻¹¹ mm/Pa, and this product is equal to the product k_{c}×rᵢₙₜ (to within 10% or even less).

During a step 22, the liquid is present at rest in the channel 10, and the temperature T_{eq} and pressure P_{eq} are defined and recorded in the processing unit 40. These values can be directly retrieved from those recorded in the calibration system 100. Alternatively, they can be defined and recorded by the user in the processing unit 40 without having been directly measured. In a further alternative, the temperature T_{eq} can be measured by means of the thermal measurement device 30 (or another temperature sensor not represented). The pressure P_{eq} can be measured by a pressure sensor (not represented) disposed, for example, at the tank 22 or a duct 23.

During a step 23, the flow actuator 20 moves the liquid in the channel 10 (constant flow rate in this example). The flow rate D is less than or equal to the predefined maximum value Dₘ. The liquid of interest is therefore heated (ΔT>0) or cooled (ΔT<0) by the thermoelastic effect, along the direction of flow imposed by the flow actuator 20.

During a step 24, while the liquid is flowing in channel 10 at flow rate D, the temperature T_{heq} of the liquid in the channel 10 is measured by means of the thermal measurement device 30. The processing unit 40 then determines the temperature difference ΔT=T_{heq}−T_{eq}.

During a step 25, the processing unit 40 determines the pressure difference ΔP from the calibration function f and the value obtained for the temperature difference ΔT.

Finally, during a step 26, the processing unit 40 determines the value of the pressure P_{eq} of the liquid flowing in the channel 10, from the pressure difference ΔP and the value of the pressure of the liquid at rest P_{eq}: P_{heq}=ΔP−P_{eq}.

Thus, the measurement system 1 makes it possible to determine the out-of-equilibrium pressure P_{heq} of the liquid flowing in the channel 10, without having to measure pressure of the flowing liquid in the channel, by taking advantage of a thermoelastic effect demonstrated by the inventors. Thus, not only is the flow of the liquid in the channel not disturbed by the pressure sensor, but the reliability of the measurement system 1 is improved insofar as the pressure is not determined by a dedicated remote pressure sensor which is local and likely to degrade, but by a thermal measurement and calibration function.

It is noted that it is possible to generate flow instabilities during the measurement phase, and thus to obtain an image of pressure variations of a flowing liquid via the measurement of a thermal image.

It is also noted that it is possible to take advantage of heating or cooling of the flowing liquid to heat or cool the channel and, hence, an outer device which would be in thermal contact (heat exchange) with the channel.

Specific embodiments have just been described. Various variants and modifications will become apparent to a person skilled in the art.

1. A measurement system configured to determine at least one pressure P_{heq} of a liquid of interest having compressibility kₘ flowing in a channel of internal radius rᵢₙₜ, the liquid of interest and the channel being selected so that a product kₘ×rᵢₙₜ is less than or equal to 12.5×10⁻¹¹ mm/Pa, the measurement system comprising:
the channel;
a flow actuator configured to cause the liquid of interest to flow in the channel, so that the liquid of interest has a ratio Vₘ/c less than or equal to 0.3, where Vₘ is a maximum velocity of the liquid of interest in the channel and where c is a velocity of sound in the liquid of interest;
a thermal measurement device configured to measure at least one temperature T_{heq} of the liquid of interest flowing in the channel; and
a processing unit configured to determine the pressure P_{heq} from the temperature T_{heq} measured and a predetermined calibration function f such that ΔP=f(ΔT), expressing a course of a pressure difference ΔP between the pressure P_{heq} and a predefined reference pressure P_{eq} of the liquid of interest at rest in the channel, as a function of a temperature difference ΔT between the temperature T_{heq} measured and a predefined reference temperature T_{eq} of the liquid of interest at rest in the channel.

2. A measurement system according to claim 1, wherein the channel has a length of less than or equal to 5 cm.

3. The measurement system according to claim 1, wherein the channel is rectilinear over its entire length and has a constant internal radius rᵢₙₜ.

4. The measurement system according to claim 1, wherein the flow actuator includes ducts connecting the channel to a pump and to a tank for the liquid of interest, the ducts having an internal radius greater than rᵢₙₜ.

5. The measurement system according to claim 1, wherein the thermal measurement device is configured to detect infrared radiation emitted by the liquid of interest and transmitted by a peripheral wall of the channel and to deduce the temperature T_{heq}, the peripheral wall being made of a material transparent to infrared radiation.

6. The measurement system according to claim 1, wherein the thermal measurement device includes at least one thermal contact sensor, disposed in contact with a peripheral wall of the channel.

7. The measurement system according to claim 6, wherein the thermal contact sensor is disposed in contact with an external face of the peripheral wall, the external face being made of a thermally conductive material so that a temperature of the external face is equal to the temperature T_{heq} of the liquid.

8. The measurement system according to claim 1, wherein the channel has an internal diameter dᵢₙₜ of between 10 μm and 1 mm.

9. The measurement system according to claim 1, wherein the thermal measurement device is configured to acquire a thermal image of the liquid of interest, and the processing unit is configured to determine a pressure image from the thermal image acquired and the calibration function f.

10. A method for determining a pressure P_{heq} of a liquid of interest moving in the channel of a measurement system according to claim 1, the method including a measurement phase comprising:
selecting a liquid of interest having compressibility kₘ and the channel having the internal radius rᵢₙₜ, so that the product kₘ×rᵢₙₜ is less than or equal to 12.5×10⁻¹¹ mm/Pa;
flowing the liquid of interest in the channel at a flow rate predefined by the flow actuator, so that the liquid has a ratio Vₘ/c less than or equal to 0.3, where Vₘ is the maximum velocity of the liquid in the channel and where c is the velocity of sound in the liquid of interest;
measuring the temperature T_{heq} of the liquid of interest flowing in the channel by the thermal measurement device, and determining the temperature difference ΔT which is then non-zero between the temperature T_{heq} measured and the predefined reference temperature T_{eq} of the liquid of interest at rest in the channel; and
determining the pressure P_{heq} of the liquid of interest using the processing unit, from the temperature difference ΔT determined, and from the predetermined calibration function f, expressing the course of the pressure difference ΔP between the pressure P_{heq} of the liquid of interest flowing in the channel and the predefined reference pressure P_{eq} of the liquid of interest at rest in the channel, as a function of the temperature difference ΔT.

11. The method according to claim 10, including a calibration phase, carried out before the measurement phase, comprising:
selecting a liquid having a compressibility k_{c} and a second channel of internal radius rᵢₙₜ of a calibration system, such that a product k_{c}×rᵢₙₜ is less than or equal to 12.5×10⁻¹¹ mm/Pa;
flowing the liquid in the second channel by a flow actuator of the calibration system at a predefined flow rate, so that the liquid having the compressibility k_{c} has a ratio Vₘ/c less than or equal to 0.3, where Vₘ is a maximum velocity of the liquid having the compressibility k_{c} in the second channel and where c is a velocity of sound in the liquid having the compressibility k_{c};
measuring a temperature T_{heq} of the liquid having the compressibility k_{c} flowing in the second channel by a thermal measurement device of the calibration system, and determining a temperature difference ΔT which is then non-zero between the temperature T_{heq} measured and a predefined reference temperature T_{eq} of the liquid having a compressibility k_{c} at rest;
measuring a pressure P_{heq} of the liquid having the compressibility k_{c} flowing in the second channel by a pressure sensor of the calibration system, and determining a pressure difference ΔP which is then non-zero between the pressure P_{heq} measured and a predefined reference pressure P_{eq} of the liquid having the compressibility k_{c} at rest;
reiterating measuring the temperature T_{heq} and the pressure P_{heq} for different flow rates of the liquid having the compressibility k_{c} in the second channel; and
determining the calibration function f, by a processing unit of the calibration system from different values of the temperature difference ΔT and corresponding values of the pressure difference ΔP.

12. The method according to claim 10, wherein the liquid of interest is selected from water, an alcohol and glycerol.

13. The method according to claim 11, wherein the liquid of interest used during the measurement phase is identical to the liquid used during the calibration phase.

14. The method according to claim 10, wherein flowing the liquid of interest is carried out by suction, so that the temperature T_{heq} measured is then lower than the reference temperature T_{eq} and corresponds to cooling of the liquid of interest; or is carried out by discharge, so that the temperature T_{heq} measured is then higher than the reference temperature T_{eq} and corresponds to heating of the liquid of interest.

15. The method according to claim 14, wherein the channel is made of a thermally conductive material, and in thermal contact with an outer device, so that cooling or heating of the liquid of interest respectively results in cooling or heating of the outer device.
